(19) United States
(12) Patent Application Publication
(10) Pub. No.: US 2022/0096968 A1
(43) Pub. Date: Mar. 31, 2022

(54) FILTER SYSTEM FOR TREATING CONTAMINATED LIQUIDS

(71) Applicant: SONNEK ENGINEERING GMBH, Wien (AT)

(72) Inventors: Werner WIESENEDER, Wien (AT); Peter LUTZ, Laugenzersdorf (AT)

(21) Appl. No.: 17/425,613

(22) PCT Filed: Feb. 6, 2020
(86) PCT No.: PCT/AT2020/060032

§ 371 Date: Jul. 23, 2021

(30) Foreign Application Priority Data
Feb. 6, 2019 (AT) A50090/2019

(51) Int. Cl. B01D 24/12; B01D 24/46; B01D 29/35; B01D 29/64; C02F 1/00

(52) U.S. Cl. CPC B01D 24/12; B01D 24/4631; C02F 1/001; B01D 29/35; B01D 29/6476; B01D 24/4694

(57) ABSTRACT

The invention relates to a filter system for treating contaminated liquids, having a filter container (11) that is equipped with a filter bed (12) comprising filter granulate as the filter material, a retaining element (13) being provided for the filter material via the filter bed. In order to allow the retaining element (13) to be lightly cleaned after backwashing and prevent filter material from being lost during the backwash, the retaining element (13) has a substantially vertically arranged filter screen (14) which is arranged at least partly outside of the filter container (11) and encloses a cavity, and liquid can flow outwards from the inside during the backwash. The cavity is open at the bottom such that retained filter material falls back into the filter bed (12). Because the flow within the filter bed (14) is oriented downwards, at least one turbine blade (18) can be provided, and a channel (16) can provided from the filter container (11) to the head space (17) of the filter screen (14). Preferably, a dissolver disc or a stirring mechanism (15) is provided in order to improve the flow formation. Alternatively, instead of a turbine blade, a funnel (15′) can be arranged on the lower end of the filter bed (14).

### TECHNICAL FIELD

The present invention relates to a filter system for treating contaminated liquids, in particular contaminated water, such as, for example, production water from the petroleum industry, the system having a container holding a filter bed comprised of filter granules as filter material, above which is provided a filter-material trap for the filter material.

### BACKGROUND OF THE INVENTION

In the production of crude oil, production water is obtained that is usually pumped out to a different location. For this purpose, the production water has to be treated, in particular filtered, beforehand. For this purpose, a packed bed filter with filter granules (for example filter sand, anthracite, activated carbon, glass, nut shells, etc.) serves as filter medium, similar to a swimming-pool filter. However, the particle size is different and substantially greater in a swimming-pool filter. In filter installations for production water, the particle size of the filter granulate is often less than 0.5 mm, so that even very fine particles are retained or filter media are used that have a low specific weight, such as, for example, activated carbon or nutshell granules.

Such bulk-layer filters with filter granules as filter medium must be backflushed regularly. Backwashing is relatively easily possible in a swimming-pool filter because hardly any material is entrained due to the high particle size and at the same time high specific weight of the sand grain.

DE 4142612 describe a filter-material trap for the filter material above the filter granulate. This filter-material trap extends over the entire cross-section of the container and prevents filter material from being discharged during backwashing.

This solution may be suitable for coarse filter material, but in the case of fine or lightweight filter material, as is used, for example, for cleaning production water, the filter-material trap tends to clog. In the event of a blockage, the container must be dismantled, the filter-material trap must be removed and cleaned, after which the filter-material trap has to be reinstalled and the container reassembled. Such interruptions should, of course, only occur in exceptional cases.

In the case of bulk-bed filters for production water, a relatively large quantity of filter material is entrained during backwashing. This is due, on the one hand, to the fact that the particle size is smaller and that smaller particles are more easily entrained. This is furthermore based on the fact that at least partly very light filter granules are used (for example activated carbon, anthracite or nutshell granules). Further, this is because oil is adsorbed to the grains, and oil is lighter than water; thus, grains that have adsorbed oil float more easily. Finally, this is because the necessary speed of the backwash medium (either a gas/water mixture or only water) is higher, it is often more than 40 m/h (gas is normally blown in beforehand to loosen the filter medium. Although lower speeds of the backflushing medium are possible, then the efficiency of the backflushing medium suffers. This frequently results in excessive differential pressure in the container

### SUMMARY OF THE INVENTION

The object of the invention is to develop a filter system of the above-described type such way that operational interruptions caused by high differential pressures can be avoided or kept as short as possible.

This object is attained according to the invention by a filter system of the type described above in that the filter-material trap is a substantially vertically extending filter mesh at least partially outside the container and defines a separation chamber and can be flowed through from inside to outside during backwashing, and in that the separation chamber is open at the bottom such that retained filter material falls back into the filter bed.

According to the invention, therefore, a filter-material trap (screen) is provided that is designed, for example, as a vertically extending cylindrical tube. Such traps are usually used for cleaning liquids: dirt particles are retained and only clean medium passes through.

However, the object according to the present invention is different: here, the dirt particles pass through and only the filter granules are trapped.

In the system according to the invention, cleaning is possible without the container itself having to be opened, and the cleaning can also be easily automated, as will be described below.

In order that the filter material can fall easily downward and as a result the filter-material trap is clogged less quickly, it is advantageous if the flow into the separation chamber takes place as much as possible from top to bottom. According to one embodiment of the invention, a passage is provided from the container to an upper space above the filter mesh, and at least one turbine blade is provided on a shaft that can be rotated inside the filter mesh by a drive. The at least one turbine blade generates a pressure difference on rotation of the shaft by the drive, and as a result creates vertical flow. The backwash liquid is therefore able to flow through the passage into the upper space above the separation chamber, whence it flows downward into the separation chamber and, in a further sequence, radially outward through the filter mesh. Thus the filter material can drop relatively easily out of the lower end of the filter mesh and fall back into the filter bed. This flow created by the at least one turbine blade also serves for cleaning the filter mesh. The cleaning is the result of the forced strong overflow at the filter mesh.

According to an embodiment of the invention, there is a dissolver disk or an agitator on the lower end of the shaft. The disk or agitator ensures flexible operation of the entire filter system and improves flow conditions in the filter-material trap. The position of the dissolver disk or agitator is adjusted for the filter medium by lengthening or shortening the shaft.

According to an alternative embodiment of the invention, a downwardly open funnel is connected to the lower end of the separation chamber, and the container forms a passage to the upper space above the filter mesh, the cross-section of which passage being larger than the cross-section of the funnel outlet. Since a funnel tapers, that is to say has a relatively small cross-section at the bottom, flow of back-flushing liquid into the separation chamber is throttled by the funnel, which flow would have in the separation chamber an upwardly directed vertical component, so that the filter material would be kept suspended for a long time. In this case, the backwash liquid is therefore preferably able to flow through the passage into the upper space of the separation chamber, whence it flows downward in the separation chamber and, in a further sequence, radially outward through the filter mesh. As a result, the filter material can sink relatively easily downward out of the filter element and fall back into the filter bed.

In this case, the cleaning system can be mechanical in that there is at least one scraper that can be moved along the inner surface of the filter mesh by a drive, or it can be hydraulic/pneumatic by providing at least one high-pressure nozzle for directing a high-pressure fluid jet against the inner surface of the filter mesh.

### BRIEF DESCRIPTION OF THE DRAWINGS

The present invention will be described in more detail with reference to the accompanying drawings.

FIG. 1 shows a cross section through a first embodiment of a filter system according to the invention; and

FIG. 2 shows the filter-material trap thereof on an enlarged scale;

FIG. 3 shows a second embodiment of a filter system according to the invention; and

FIG. 4 shows the filter-material trap thereof on an enlarged scale.

### SYSTEM FOR CARRYING OUT THE INVENTION

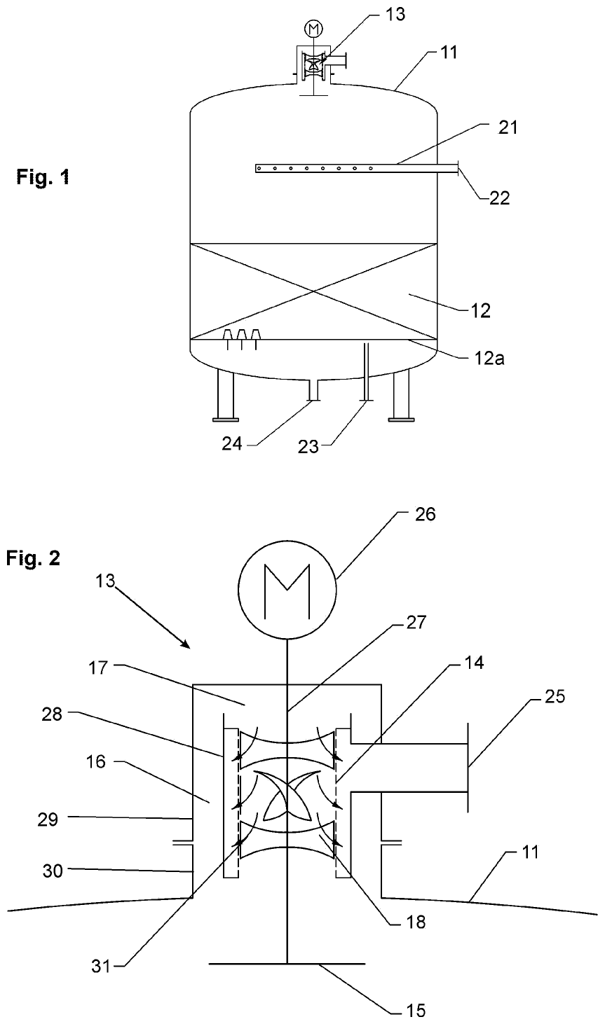

The filter system according to FIGS. 1 and 2 has a container 11 in which a filter bed 12 on a nozzle floor 12a is provided. A disperser 21 above the filter bed 12 and that receives the liquid to be filtered from an inlet port 22 and distributes it over the filter bed 12. The liquid flows through the filter bed 12 and the nozzle floor 12a to an outlet port 24 at the lowest point of the container 11.

For backflushing the filter, a backflushing inlet port 23 is provided through which a backflushing gas can be introduced, and the backflushing gas or liquid exits via the outlet port 24. Normally, the filter bed 12 is first loosened by gas, after which liquid is introduced, optionally together with the backflushing gas, into the filter bed.

In conventional filter systems, the backwash liquid is mostly outputted via the inlet port 22, but this has the disadvantage that filter material is entrained, in particular with a high throughput of backwashing liquid that is desired in order to efficiently clean the filter bed 12.

In order to eliminate this disadvantage, according to the invention a filter-material trap 13 is provided. This filter-material trap 13 is located in the uppermost region of the container 11, partially inside and partially outside the container 11. It consists essentially of a cylindrically tubular filter mesh 14. This filter mesh 14 is located in a tube 28, so that an annular chamber is formed between the tube 28 and the filter mesh 14. This annular chamber is closed at the top and bottom and is connected to a backwash-fluid outlet port 25.

The tube 28 is surrounded by an outer tube 29 tightly connected to a collar 30 of the container 11. There is thus a further annular space between the pipe 28 and the outer pipe 29 or the collar 30 that forms a passage 16 for supplying the backflushing liquid into the upper space 17 of the filter-material trap 13. The upper space 17 connects the passage 16 to the interior of the filter mesh 14, but the annular chamber between the tube 28 and the filter mesh 14 is, however, separate.

The filter-material trap functions as follows:

During backwashing, water is pumped from below via the outlet port 24 into the container 11 and flows through the filter bed 12, thereby detaching contaminants (solids, oil, etc.) and carries them upward.

The process becomes more efficient at a higher backflushing rate (m³/m²·h), but in conventional filters this entails the risk of a filter-material discharge.

In order to avoid this risk, in the filter system according to the invention, the backwash water is conducted into the passage 16 and from there via the upper space 17 down into the interior of the tubular filter mesh 14.

Inside the filter mesh 14 there is a shaft 27 with turbine blades 18 that are rotatable by a drive 26. During back-flushing, the drive 26 is switched on and the turbine blades 18 generate a desired flow and scrape the inner surface of the filter mesh 14. This results in a main flow indicated by arrows 31 during the backflushing process, so that flow is produced in the interior of the filter mesh 14 whose vertical component is directed downward. The backwash water then flows through the filter mesh 14 whose mesh size is selected as a function of the particle size of the filter medium, from inside to outside and finally reaches the backwash liquid outlet port 25, where the backwash water is discharged with the contaminants. Since the vertical component of the flow in the interior of the filter mesh augmented by the vertically extending turbine blades 18 is downward, entrained filter granules are flushed to a considerable extent already during the back-flushing toward the filter bed 12 and do not reach the filter mesh 14 at all. The desired flow inside the filter mesh 14 and thus also in the container 11 can be influenced by a dissolver disk or an agitator 15 at the end of the shaft 27. The position of the dissolver disk or agitator 15 can be defined according to the filter medium.

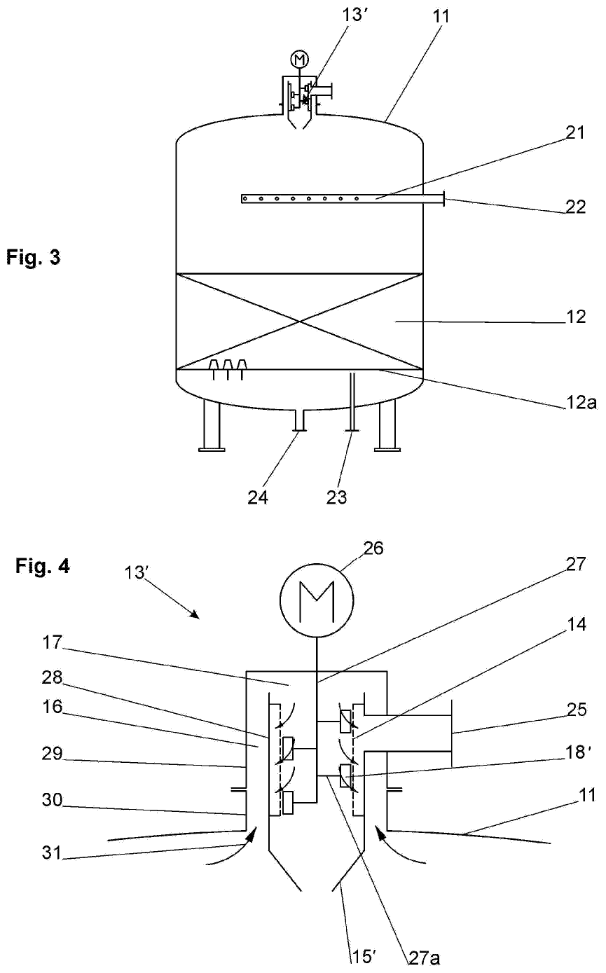

The filter system according to FIGS. 3 and 4 differs from the filter system just described in that the filter mesh 14 has a funnel 15′ at the bottom and that no turbine blades are provided for generating a forced flow. The inclination of the wall of the funnel 15′ is so steep that filter material cannot remain thereon. In this embodiment, although in some cases the backwash water also flows through the opening of the funnel 15′ into the interior of the filter mesh 14, this proportion can be kept low if the cross-section of the passage 16 is considerably larger than the cross section of the opening of the funnel 15′. Thus, in this case too, a main flow 31 is formed whose vertical component is at least largely directed downward, so that even in this case the filter granulates carried along are flushed to a considerable extent already during the back-flushing toward the filter bed 12 and do not reach the filter mesh 14 at all.

Nevertheless, the filter mesh 14 tends to clog. For this reason, a shaft 27 driven by a drive 26, in particular by an electric motor, is provided inside the filter mesh 14, which shaft 27 has radially projecting arms 27a each carrying a respective scraper 18′ that slides along the inner surface of the filter mesh 14. During back-flushing or only afterward, the drive 26 is switched on, and the scrapers 18′ clean the filter mesh 14.

The filter mesh 14 can also be cleaned hydraulically, in particular with a water jet.

The retained filter material falls back into the container 11 at the latest after backwashing via the funnel 15′ at the lower end of the filter mesh 14.

1. A filter installation for treating contaminated water, the installation comprising:
a container;
a filter bed in the container and formed of filter granules as filter material;
a filter-material trap for the filter material above the filter bed and formed of a substantially vertically extending filter mesh that is at least partially outside the container, that forms a separation chamber, and that can be flowed through from inside to outside during backwashing, the separation chamber being downwardly open such that retained filter material falls back into the filter bed.

2. The filter system according to claim 1, further comprising:
a cleaning system for the filter mesh.

3. The filter system according to claim 2, further comprising:
a passage extending from the container to an upper end of the separation chamber of the filter mesh, and
at least one turbine blade provided on a shaft that can be rotated inside the filter mesh by a drive.

4. The filter system according to claim 3, in that further comprising:
a dissolver disk or an agitator at an end of the shaft.

5. The filter installation according to claim 1, further comprising:
a funnel that extends downward from a lower end of the separation chamber, and
a passage extending from the container extending to an upper end of the separation chamber of the filter mesh, a cross-section of the passage being greater than a cross-section of an outlet end of the funnel.

6. The filter system according to claim 2, wherein the cleaning system comprises at least one scraper is provided that can be moved along an inner surface of the filter mesh by a drive.

7. The filter system according to claim 2, wherein the cleaning system comprises at least one high pressure nozzle for directing a high-pressure fluid jet against an inner surface of the filter mesh.

8. A filter system comprising:
a container having a lower outlet;
a filter bed in the container above the outlet;
an inlet port for introducing a liquid to be filtered into the container above the filter bed;
a concentric inner and outer tube extending upward from the container and forming an annular passage opening downward into the container and upward at an upper end of the outer tube;
a tubular filter mesh of mesh size adapted to trap particles forming the filter bed and concentrically inside the inner tube; and
a backwash-liquid output port open through the outer tube toward the mesh such that backwash liquid passing through the mesh is stripped of particles of the filter bed by the mesh and pass downward in the mesh and back into the filter bed.

9. The filter system according to claim 8, further comprising:
a downwardly tapering funnel on a lower end of the inner tube.

10. The filter system according to claim 8, wherein the inner and outer tubes form a compartment surrounding the mesh, into which the backwash-liquid outlet port opens, and that is upwardly and downwardly closed.
